(19) United States
(12) Patent Application Publication
(10) Pub. No.: US 2004/0189606 A1
(43) Pub. Date: Sep. 30, 2004

(54) Mouse having a massage feature

(75) Inventor: EAKKAPONG POWPONG, NAKORNRATCHASIMA (TH)

Correspondence Address: Mr.EAKKAPONG POWPONG, 292/1 ASADANG Rd. Tumbon, NAI MUANG Amphur MUANG, NAKORNRATCHASIMA, 30000, TH

(73) Assignee: EAKKAPONG POWPONG, NAKORNRATCHASIMA (TH)

(21) Appl. No.: 10/709,429

(22) Filed: May 5, 2004

(30) Foreign Application Priority Data
May 5, 2004 (TH) 083219

(51) Int. Cl. G09G 5/08

(52) U.S. Cl. 345/163

(57) ABSTRACT

A peripheral input device for controlling movement on the screen More particularly, having massage feature. User can control the massaging of mouse by switch cooperate with light sensing and adjustable level of massaging The massaging help user relax and treat fatigue in effective area while using. A massage disabling cover is use for assemble into mouse housing and use mouse without massaging.

### BACKGROUND OF INVENTION

1. Field of the Invention

The present invention relate generally to an input device for use in a computer system. More particularly, the present invention relates to a mouse having massage feature.

2. Description of the Related Art

Most computer systems, as for example general purpose computer such as portable computers and desktop computers, receive input from a user via an input device such as a mouse. As is generally well known, the mouse allows a user to move an input pointer(e.g., curser) and to make selections with respect to a graphical user interface(GUI) on a display screen. The mouse typically include a trackball or optical sensor(locate at the bottom side of the mouse) for translating the motion of the users hand into signals that the computer system can use. For example, by positioning the mouse on a desktop and moving it thereon, the user can move an input pointer or cursor in similar directions within the GUI. The mouse also conventionally includes one or more button, which are located on the top side of the mouse. These one or more button, when selected, can initiate a GUI action such as menu or object selections. The one or more buttons are typically provided by one or more button caps (e.g. Through an opening in the housing).

Recently, a scroll wheel has been added to the mouse to give the user scrolling functionality. The scroll wheel has been saves time and steps, and allows a user to move through documents by physically rolling the wheel forward or backward instead of clicking on the scroll bar displayed on the GUI. The scrolling was implemented by selecting the scroll bar with the mouse, and moving the scroll bar on the GUI by moving the mouse up or down. A switch has also been incorporated into some mice for changing the mouse from a cursor control device. In cursor control mode, mouse movement control cursor movements, and in scroll control mode, mouse movements control scroll movement. In most cases, the scroll wheel and switch require a separate mechanical component for actuating the scrolling feature. These device also generally require the mechanical component to be mounted in the mouse with portion of it protruding out of a mouse housing to allow a user's finger access, i.e., the housing includes a cut out to allow mechanical component to protrude therethrough.

There are continuing efforts to improve their form, functionality and feel, For example several form of housing and position of operating region make user more comfortable and relaxing their muscle. As well known and use widely, The massaging to be useful in curing and relieving muscle stress, it would be desirable to provide the massage mechanism for a mouse that allow user able to choose activation of mechanism, including adjustable leveling of massaging, disabling and the massage disabling cover which will assembly into housing for more efficient disabling and using a mouse like unavailable massage mechanism.

### SUMMARY OF INVENTION

The invention relates, in one embodiment, to a peripheral input device for controlling movements on a display screen. The massage mouse include a housing, the massage mechanism carried by the housing and massage disabling cover which assembly into housing for massage mechanism disabling and hide the massage mechanism in protruding portion out of mouse housing.

The invention relates, in another embodiment, to a mouse having massage region that is integrated into housing of a mouse. The massage region represent working area of a massage mechanism disposed inside the housing.

The invention relates, in another embodiment, to a mouse having massage region that is integrated into housing of a mouse and the light detect system which use LDR as light sensor and integrated into housing of a mouse. The light detect system is configured to detect user's grip for activate massage mechanism in massage region.

The invention relates, in another embodiment, to a mouse having a massage region that is integrated into a housing of the mouse and adjustable leveling of massage system which use adjustable resistor which is mounted in the mouse with portions of it protruding out of the mouse housing to allow a user is finger access, i.e., the housing includes a cut out to allow a part of adjustable resistor to protrude therethrough.

### BRIEF DESCRIPTION OF DRAWINGS

The invention will be readily understood by the following detailed description in conjunction with the accompanying drawings, wherein like reference numerals designate like structural elements, and in which:

FIG. 1 is a prospective diagram of peripheral input device, in accordance with one embodiment of present invention.

FIG. 2 is a simplified diagram of the peripheral input device components, in accordance with one embodiment of present invention.

FIG. 3 is a simplified diagram of the switch, in accordance with one embodiment of present invention.

FIGS. 4A-4F Show the plan view of a mouse having massage feature in accordance with one embodiment of present invention.

FIG. 4G Show a perspective view of a mouse having massage feature in accordance with one embodiment of present invention.

FIGS. 5A-5F Show the plan view of the massage disabling cover in accordance with one embodiment of present invention.

FIGS. 5G-5H Show the perspective view of the massage disabling cover in accordance with one embodiment of present invention.

FIG. 6A-6F Show the plan view of a mouse having massage feature assembled with massage disabling cover in accordance with one embodiment of present invention.

FIG. 6G Show a prospective view of a mouse having massage feature assembled with massage disabling cover in accordance with one embodiment of present invention.

FIGS. 7A-7F Show the plan view of the massage mechanism with sectional view of massage region of housing in accordance with one embodiment of present invention.

FIG. 7G Show a prospective view of the massage mechanism with sectional view of massage region of housing in accordance with one embodiment of present invention.

FIG. 8 Show an exploded view of the massage mechanism of present invention.

FIGS. 9A-9F Show the plan view of the cylindrical incline with gear in accordance with one embodiment of present invention.

FIGS. 9G Show a prospective view of the cylindrical incline with gear in accordance with one embodiment of present invention.

FIG. 10 is an end, cross-section view of massage region which cut out of housing with the massage button and spring which is components of the massage mechanism, in accordance with one embodiment of present invention.

FIG. 11 Show light sensing system schematic according to the present invention.

### DETAILED DESCRIPTION

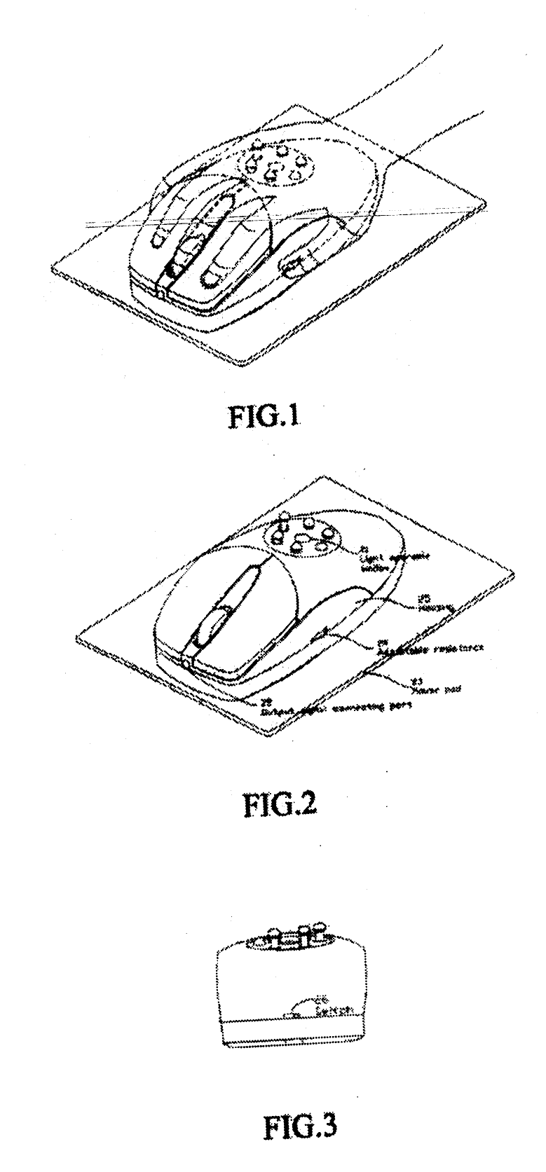

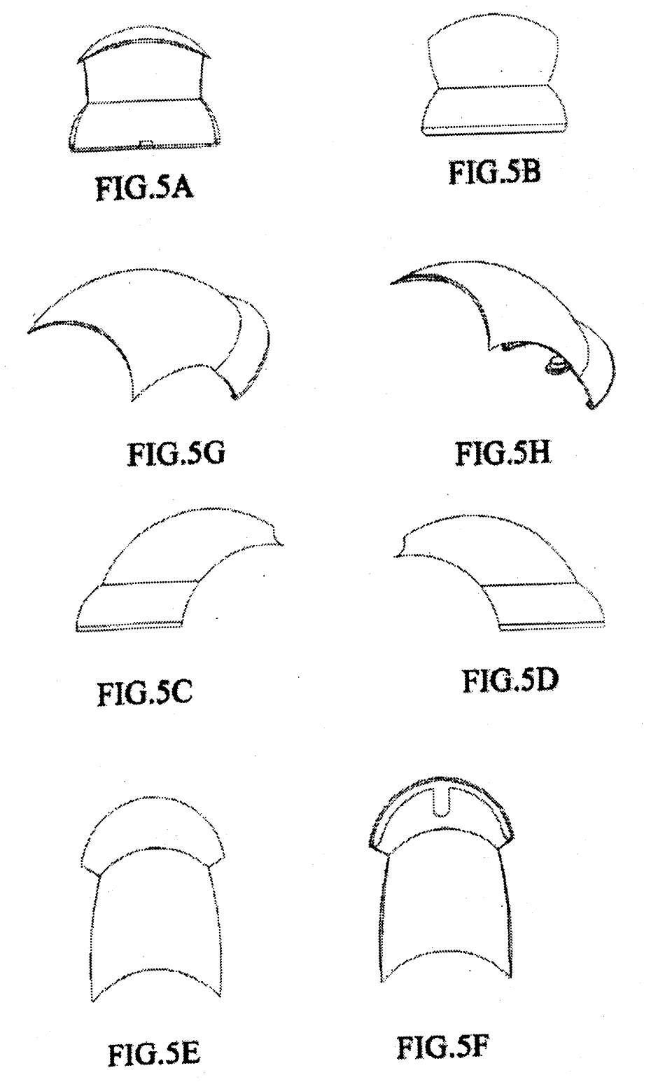

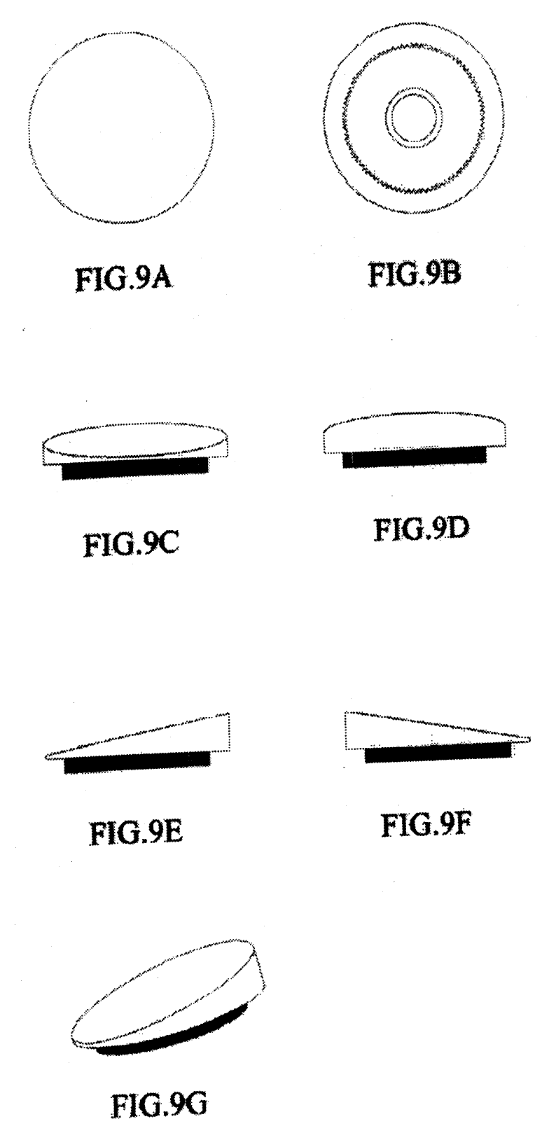

Embodiments of invention are discussed below with reference to FIGS. 1-11. It is therefore a primary object of the invention to provide a mouse having massage feature. The mouse not only have movement tracking mechanism for cursor indication, but also equipped with massage mechanism.

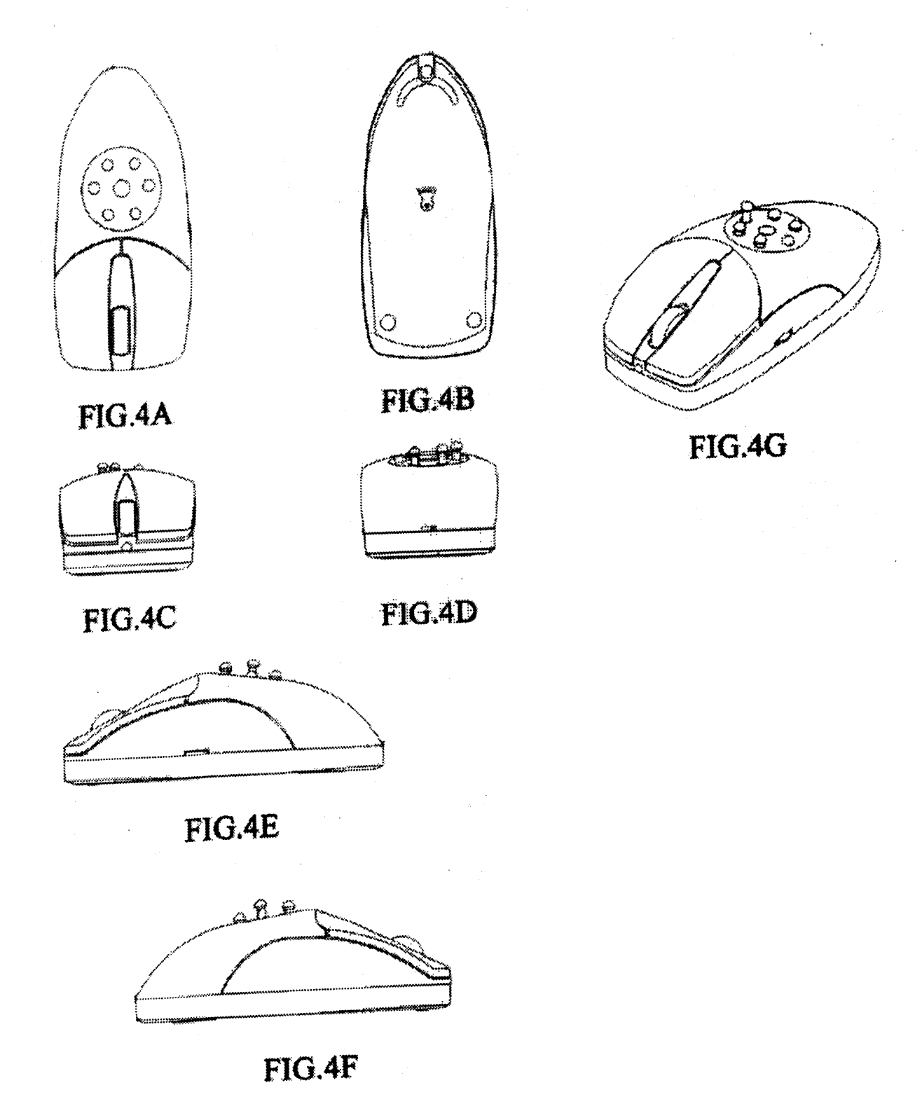

FIGS. 4A-4F is plan views of a mouse having massage feature in accordance with one embodiment of the invention, By peripheral input device, it is meant a mouse having massage feature capable to connecting and sending information to host system such as a computer system by cable connection. Alternatively, a radio frequency (RF) link or optical infrared (IR) link maybe used in order to eliminate the cable. As the peripheral in put device a mouse having massage feature configured to implement one or more task (e.g., Specific function) in the host system. For example may use to control movements and/or perform actions on a display screen of the host system (e.g., via a graphical user interface).

The mouse having massage feature in FIGS. 4A-4G include housing that provides a structure for gripping the device during use thereof (e.g., handheld). Refer to FIG. 2 The housing No. 25 also provide a structure for enclosing, containing and/or supporting the internal component of a mouse having massage feature and supporting the massage disabling cover to assemble into it. By the way, example the internal components may correspond to circuitry capable of processing/sending user inputs to the host system. That is, contour of the housing embodies the outward physical appearance. The contour may be rectilinear, curvilinear or both.

The mouse having massage feature in FIGS. 4A-4G generally include massage region is configured to provide massage mechanism which is mounted inside housing work through therefrom. The massage region is a portion of housing and component of massage mechanism for massaging user are massage button, say the massage mechanism will work through massage region by massage button protruding out of housing.

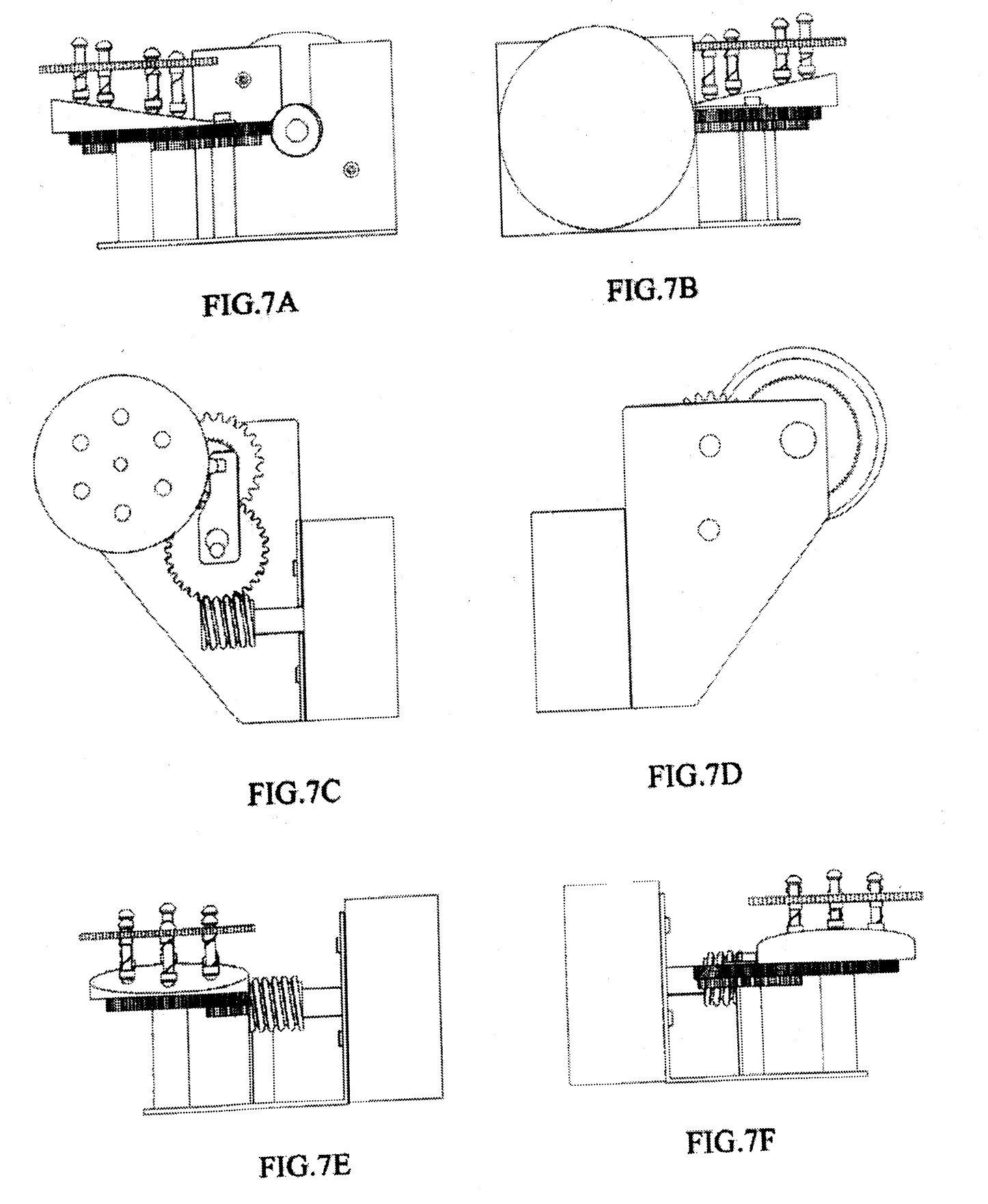

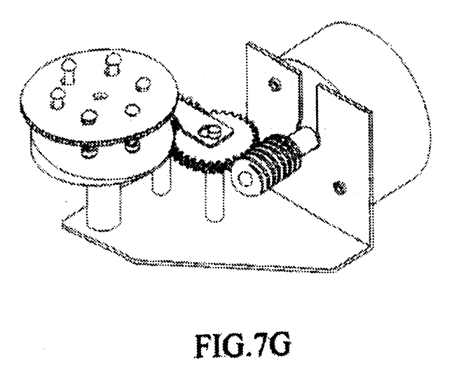

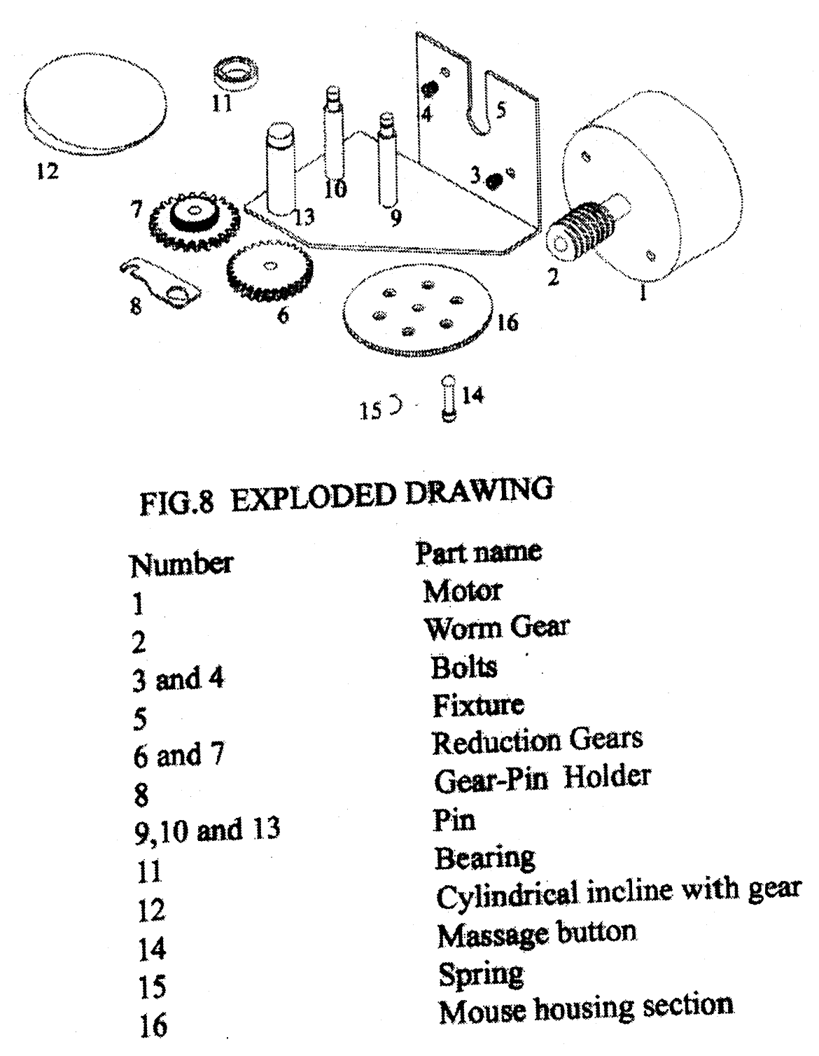

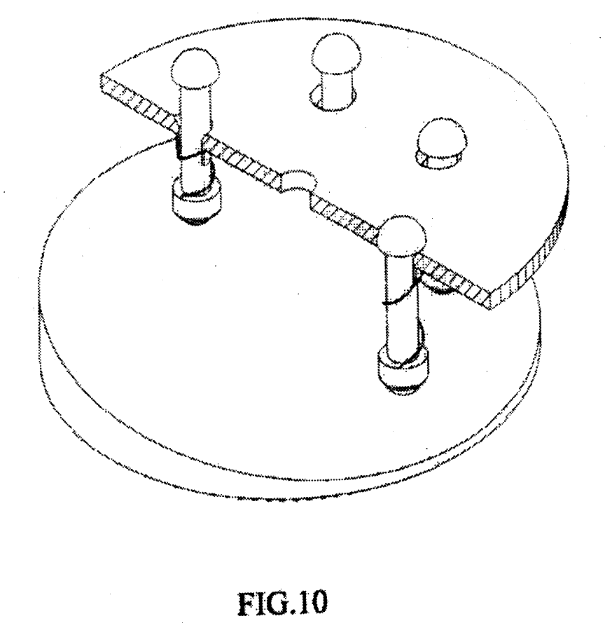

The massage mechanism in FIGS. 7A-7G is mounted inside housing and is configured to work through the massage region. In activation refer to FIG. 8 Exploded view of massage mechanism; an output shaft rotatebly driven by motor. A worm gear is mounted at the tip of output shaft will rotate and drive the first reduction gear by their contact gearteeth motivation. A first reduction gear continuing drive a second reduction gear. Also a second reduction gear continuing drive the cylindrical incline with gear in order, by their contact gearteeth motivation. The rotation of cylindrical incline let the massage button reciprocating move along designed hole in massage region. The reciprocating move character of massage button take place due to cylindrical incline is continuously rotatebly driven, said more than one revolution, and The tip of massage button in cylindrical incline touching side is roller or other relate form is induced to move while designed the massage button which is mounted through hole in massage region, so the direction of massage button movement is limit; So the massage button will reciprocating move through designed hole in massage region. The spring is locate between massage button and inside surface of housing as shown in FIG. 10.

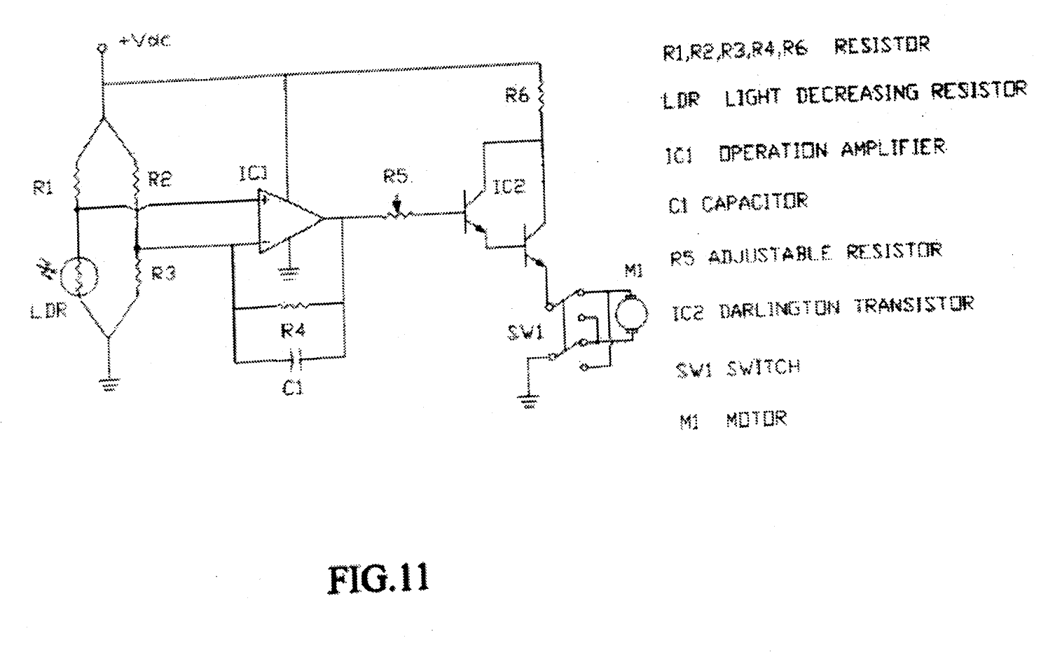

Refer to FIG. 11 The light detect system which use Light Decreasing Resistor (LDR), as light sensor, is configured to work through the light operable window which is made up a substantial portion of the housing and is formed from light transmissive material and/or translucent material. The light detect system use for allow user able to activate the massage mechanism while catching the massage mouse or other light obstruction performance which not allow the light normally passthrough the light operable window example covering an opaque material over the light operable window. Meanwhile, LDR will decreasing electric resistance and the positive voltage signal will proceed from operation amplifier under adjustable resistance controlling, the adjusted electric current from source is supplied to motor passthrough the darlington transistor and switch. Darlington transistor in this schematic use as current multiplier, said adjusted current through adjustable resistor will use as base current by darlington transistor and multiplied current is supply from source passthrough to supply motor. The switch use for close and unclosed circuitry selection; Said use as the preliminary operation for activate the massage mechanism in turn on position of switch and light due to there are cooperation of switch and the light detect system using to complete the massage mechanism activation. Furthermore, The massage mechanism is not actuated in turn off position. Refer to DPDT (Double Pole Double Throw) Switch is chosen for directional rotation motor control. Because of DPDT switch able to select clockwise and counterclockwise rotation of motor output shaft which effect to rotational direction of cylindrical incline; portion of cylindrical incline with gear and directional of the massage button interchange.

Refer to FIG. 8, The exploded view of the massage mechanism. The motor is mounted into fixture by screws and a worm gear is mounted at tip of output shaft. A first reduction gear No. 6 is located at pin No.9, and a second reduction gear No. 7, is locate at pin No.10,The cylindrical incline with gear No. 12 is located at pin No.13, with assembled bearing No. 11. The bearing use for support the rotation of cylindrical incline with gear. Pin No. 9, 10 and 13 is fixed into fixture perpendicularly respect to fixing region plane of fixture The massage button is configured to work through the desired hole of massage region, portion of housing. The spring is locate between massage button and inner surface of massage region, portion of housing.

The output signal from electric circuitry is transmitting to outside device through either an output cable or a wireless transmitting circuitry. In case of an output cable is protrude passthrough housing at an output transmitting region No. 22, In case of a wireless transmitting circuitry is transmitting an output signal, an output transmitting region will change it form to be signal transmitting window which formed from signal transmissive material and/or a translucent material and makes up a substantial portion of the housing.

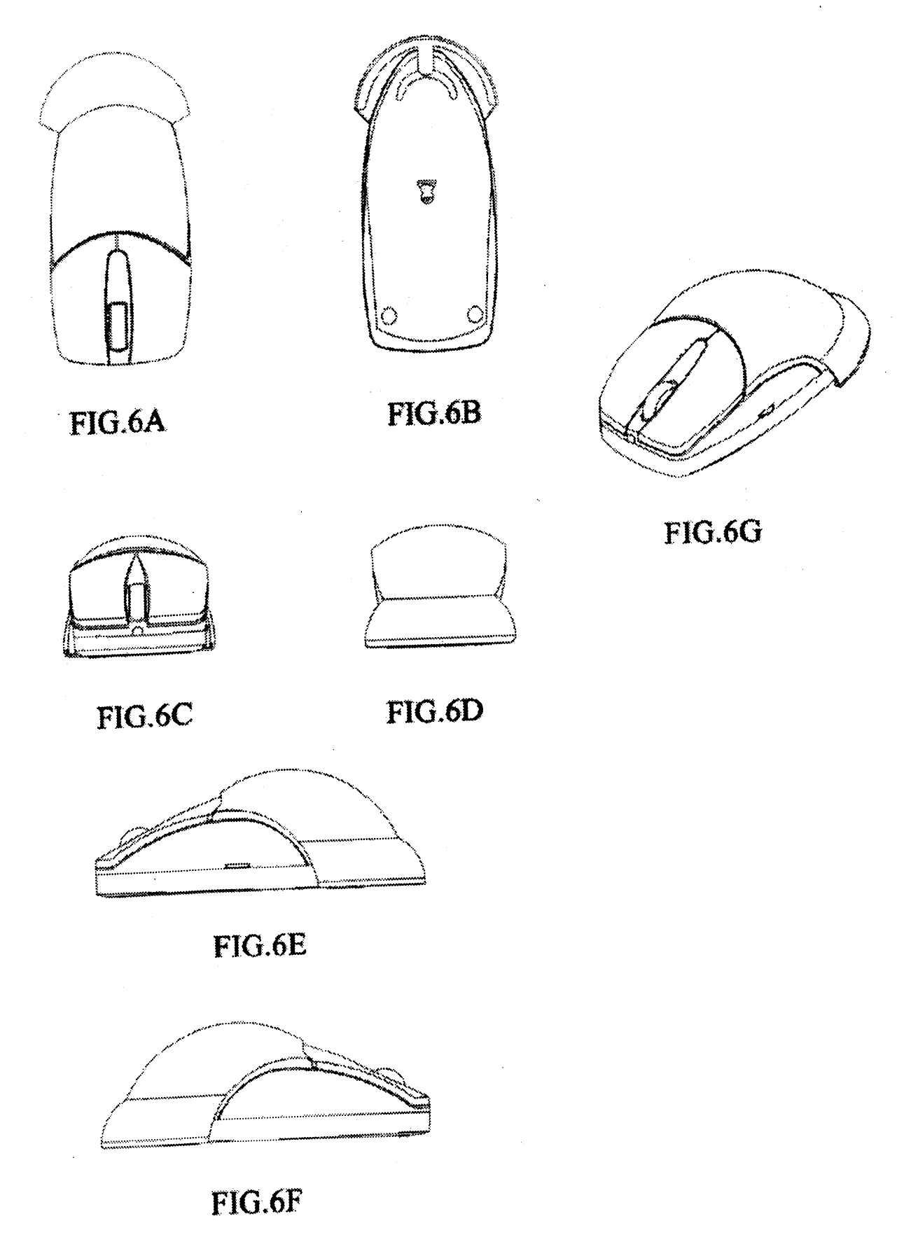

Refer to FIGS. 6A-6G, The massage disabling cover is for assemble into housing to help user fully disabling massaging or massage mechanism. Proper assembly, In a preferred embodiment, The massage disabling cover have any desired shape suitable to hide the massage region. User is grip the assembled set of the mouse having massage feature with the massage disabling cover without touching the massage region. Furthermore, The massage disabling cover have any desired shape to provide comfortable grip.

It is understood, of course, that while the form of the invention herein shown and described constitutes a preferred embodiment of the invention, it is not intend to illustrate all possible form thereof. It will also be understood that the words used as words of description rather than limitation, and that various changes may be made without departing form the spirit and scope of invention disclosed.

Although not shown, the mouse having massage feature may also include one or more buttons that provide clicking for performing action on the display screen. By way of example, the action may include selecting an item on the screen, opening a file or document exacting instructions, starting program, viewing a menu, and/or the like. The buttons may be widely varied. For example, the buttons may be mechanical buttons that are disposed through an opening in the housing or a unified button/housing that incorporates the functionality of a button (or button) directly into the housing the mouse having massage feature may also be a combination of the above (e.g., mechanical buttons and unified button housing). In the illustrated embodiment, the clicking action is provide by a unified button housing and thus there are no separate mechanism button.

Additionally, The mouse having massage feature for performing additional movement on the display screen (e.g., by providing positional data to the host). Examples of position detection mechanism, which may be used, are optical arrangements, trackball arrangements joystick arrangements, Mouse pad arrangement and the like. The position detection mechanism may provide functionality similar to the mouse pad for example, the mouse pad as well as the position detection mechanisms may be used to perform cursor movement.

In one embodiment, the position mechanism provides positional data corresponding to movements of the housing when its moved across surface (e.g., a desktop), By way of example the position detection mechanism, both of which are commonly used in mice. Further, the position detection mechanism is generally positioned on the bottom side of the device (rather than on the top side where the touch pad, i.e., movement sensitive areas, are located) In one implementation, a bottom side of the housing has an external contour that substantial conforms to the contour of flat surface such as a desktop.

The term “scrolling” as used here in generally pertains to moving displayed data or images (e.g., text or graphics) across a viewing area on a display screen so that a new set of data or image (e.g., line of text or graphics) is brought into view in the viewing area. In most cases, once the viewing is full, each view set of data appears at the edge of the viewing area and all other sets of data move over one position. That is, the new set of data appears for each set of data that moves out of the viewing area. In essence, scrolling allows a user to view consecutive sets of data currently outside of the viewing area. The portion of the display screen (e.g., window frame). By way of example, the scrolling may be used to help perform internet browsing, spreadsheet manipulation, viewing code, computer aided design, and the like.

In one embodiment, vertical scrolling is implemented finger is moved across the scrolling region in a first direction, as for example, from front of back or back to front, This particular embodiment is shown in FIGS. 1A-1F In the case of vertical scrolling when a user scrolls (or pans) down, each new set of data appears at the bottom of the viewing area and all other of data appears at the bottom of the viewing area and all other sets of data move up one position. If the viewing area is full, the top set of data moves out of the viewing area. Similarly, when user scrolls (or pan) up, each new set of data appear at the top of the viewing area and all other sets of data move down one position. If the viewing area is full the bottom set of data move out of the viewing area.

1. A peripheral input device for controlling movement on a display screen. More particularly, having massage mechanism. The mouse having massage feature comprising: a housing; the massage mechanism; and a massage disabling cover use as option for using mouse without massaging.

2. Mouse having massage feature as recite in claim 1, wherein massage mechanism make up a substantial portion of housing.

3. Mouse having massage feature as recite in claim 2, wherein the massage mechanism which control by switch cooperate with the light sensing system. An adjustable level of massaging is included.

4. Mouse having massage feature as recite in claim 3, wherein adjustable level of massaging is neglect.

5. Mouse having massage feature as recite in claim 3, wherein use the Light Decreasing Resistor (LDR) as the light sensing device.

6. Mouse having massage feature as recite in claim 5, wherein the light operable window make up a substantial portion of the housing.

7. Mouse having massage feature as recite in claim 6, wherein housing is formed a light transmissive material.

8. Mouse having massage feature as recite in claim 6, wherein housing is formed a translucent material.

9. Mouse having massage feature as recite in claim 6, wherein LDR is configured to work through the light operable window.

10. Mouse having massage feature as recite in claim 3, wherein the mouse device is mechanical mouse.

11. Mouse having massage feature as recite in claim 3, wherein the mouse device is optical mouse.

12. A method of massaging mechanism controlling which electrical circuit schematic as shown as FIG. 11. The circuit comprising: Switch; ON and OFF position is selected for close and open the massage mechanism controlling circuit. LDR will increase resistance in lower light receiving status and when voltage from source was supplied to the circuit and switch is turn ON position. LDR is configured at light operable window is in dark condition, say user catch the mouse. The voltage signal from operation amplifier (Op-Amp) is positive under adjusting of adjustable resistance the controlled current from source will supply to motor which drive the massaging mechanism. limit current resistor use for limit current supply to motor.

13. A method of massaging mechanism controlling as recite in claim 12, wherein neglect the adjustable resistor (R5), capacitor (C1), limit current resistor (R6) from circuit.

14. The massaging mechanism comprising: a motor is mounted into fixture an output shaft rotatably driven by motor and protruding therefrom, a worm gear is mounted into motor shaft and it gearteeth contact with gearteeth of the reduction gears; is mounted into pins which fix into fixture this reduction gear use for reduce the rotation speed and drive cylindrical incline with gear by their contact gearteeth. The rotation of cylindrical incline with gear let the massage button alternately move along the desired hole in massage region; a portion of housing. Between the massage button and housing support by springs. The reduction gear is mounted into pin will prevent slipping by gear-pin holder.

15. The massaging mechanism as recite in claim 14, wherein number of reduction gear is at least one or unavailable.

16. The massaging mechanism as recite in claim 14, wherein springs for support theirs alternate movement will be substitute by elastic material.

17. The massaging mechanism as recite in claim 14, wherein numbers of massage button at least one or more.

18. The massaging mechanism as recite in claim 17, wherein the tip of massage button at cylindrical incline contact side is roller form and the like.

19. The massaging mechanism as recite in claim 17, wherein the tip of massage button at cylindrical incline contact side is sphere, cut off sphere or ellipse form and the like.

20. The massaging mechanism as recite in claim 14, wherein the rotation of cylindrical incline let the massage button alternately move along the desired hole of massage region; a portion of housing.

21. The massaging mechanism as recite in claim 20, wherein the cylindrical incline is formed by number of incline at least one of their one rotation loop.

22. The massaging mechanism as recite in claim 14, wherein The tail of massage button in user touching side are sphere, cut off sphere, ellipse, cube, rectangle, oval and the like.

23. The massaging mechanism as recite in claim 22, wherein the tail of massage button in user touching side is wrapped by elastic material.

24. The mouse having a massage feature as recite in claim 3, wherein transmitting signals to outside devices through an output cable.

25. The mouse having a massage feature as recite in claim 3, wherein transmitting signals to outside devices through a wireless transmitting circuitry.
